(19) United States
(12) Patent Application Publication
(10) Pub. No.: US 2005/0030279 A1
(43) Pub. Date: Feb. 10, 2005

(54) Multi-functional pointing and control device

(76) Inventor: Liang Fu, Potomac, MD (US)

Correspondence Address: Liang Fu, 12046 Gatewater Drive, Potomac, MD, 20854, US

(21) Appl. No.: 10/636,745

(22) Filed: Aug. 8, 2003

(51) Int. Cl. G09G 5/00

(52) U.S. Cl. 345/156

(57) ABSTRACT

A general and unified method for controlling multiple functions of a computer or other equipment is presented. A mode-selection means allows users to select a mode, and in each mode the controls map to a subset of functions. Once a mode is selected, all controls are available and are dedicated to the subset of functions belonging to the selected mode. Therefore, the controls are shared by all functions. The multi-functional pointing and control device of the present invention can easily support more functions, has a simple structure, uses fewer parts, requires less signal processing, and has higher usability. Increasing the capability has a minimal impact on the system. The present invention can be applied to almost any prior-art basic-type or multi-functional pointing and control device, to increase its capability (more functions), simplify its structure, reduce its signal processing and data transmission load, and improve its usability, while adopting the remaining components with little or no modification.

### BACKGROUND OF THE INVENTION

1. Field of Invention

This invention relates to pointing and control devices, especially multi-dimensional and multi-functional pointing and control devices.

2. Prior Art

Pointing and control devices provide convenient interfaces for people to interact with computers and other types of equipment. The most popular pointing and control devices include mouse, trackball, touch pad, and joystick (or the like). A basic-type pointing and control device, such as a basic computer mouse, comprises (1) a motion control that is responsible for generating two-dimensional (2-D, vertical and horizontal) motion-control signals indicative of direction and magnitude; (2) two switch controls that are responsible for generating binary (on and off) switch-control signals; and (3) an electronic circuitry, including a microprocessor and a communication link (cable or wireless), that processes and formats these control signals into suitable form, and communicates them with the computer or the equipment via the communication link. The functions of a basic-type pointing and control device include moving the cursor (with the motion control), making selections (with the switch controls), and dragging an object (with the motion control and a switch control). A user operates the motion control of a pointing and control device either by sliding the device on a flat surface (mouse) or with fingers (track ball, touch pad, joystick, etc.), and operates the switch controls (click or double click) with fingers.

Because pointing and control devices are easy to use, many computer programs have been developed to allow users to interact in a variety of ways using pointing and control devices. Many other types of equipment have also been designed to be controlled by pointing and control devices in a variety of ways. This trend is likely to continue for the foreseeable future.

For more complex and sophisticated interactions, a basic-type pointing and control device may become inconvenient or inadequate. For example, current word processing and spreadsheet programs have scrolling capability. With a basic-type pointing and control device, a user has to click the horizontal or vertical scrolling buttons or drag the corresponding handles to scroll through a document. To simplify the scroll process, roller-wheel controls (and the equivalents) have been created and added to the basic-type pointing and control devices. A roller-wheel control is essentially a one-dimensional (1-D) motion control. It generates bi-directional motion signals when being turned. These signals are processed in a separate signal-processing channel of the circuitry and are used for image scroll. At present, most pointing and control devices have one roller-wheel control for vertical scroll. Some pointing and control devices have two roller-wheel controls, one for vertical scroll and the other for horizontal scroll. Another example is that some computer aided design (CAD) programs and graphics programs are capable of creating and manipulating solid objects. Since six degrees of freedom are needed to completely determine the position and orientation of a solid object, it would be desirable for such applications that a pointing and control device is capable of controlling all those six degrees of freedom. There are many other types of desirable functions, such as panning or zooming images, adjusting brightness and contrast of a screen display, adjusting sound volume, controlling a device or a piece of equipment in multiple dimensions, etc.

In response to these increasing demands, many multi-dimensional and multi-functional pointing and control devices have been invented. Since a dimension control can also be considered a function, for simplicity and consistency the term “function” will be used in its broadest sense. Likewise, any pointing and control device with any functionality or capability beyond those of a basic-type pointing and control device will be referred to as a multi-functional pointing and control device.

The prior-art multi-functional pointing and control devices are basically inspired by the scroll wheel concept. The following are some typical examples. U.S. Pat. No. 4,891,632 to Chang (1990), U.S. patent application Ser. No. 10/000,629 of Ore-Yang (2002), and U.S. patent application Ser. No. 09/790,354 of Meriaz (2002) add a trackball to a basic-type mouse. U.S. Pat. No. 6,480,184 to Price (2002) and U.S. Pat. No. 6,204,838 to Wang et al. (2001) add joystick-like controls to a basic mouse. U.S. Pat. No. 6,198,473 to Armstrong (2001), U.S. Pat. No. 5,883,619 to Ho et al. (1999), and U.S. Pat. No. 5,771,038 to Wang (1998) add four-directional switch to a basic-type mouse. U.S. Pat. No. 6,166,721 to Kuroiwa et al. (2000) adds an up-scroll/down-scroll switch control to a basic-type mouse. U.S. Pat. No. 6,353,432 to Chiu et al. adds four varistors to a basic-type mouse. U.S. Pat. No. 5,181,181 to Glynn (1993) adds three angular rate sensors to a basic-type mouse. U.S. Pat. No. 6,164,808 (2000) and U.S. Pat. No. 6,466,831 (2002), both to Shitaba et al., add gyroscopes to a basic-type mouse. U.S. Pat. No. 5,793,354 to Kaplan (1998) adds three gain controls to a basic-type mouse. U.S. Pat. No. 5,963,197 (1999) and U.S. Pat. No. 5,473,344 (1995), both to Bacon et al., and U.S. Pat. No. 5,313,230 to Venolia et al. (1994) add two roller-wheel controls to a basic-type mouse. U.S. Pat. No. 6,215,473 to Suzuki (2001) and U.S. Pat. No. 6,307,465 to Kayama et al. (2001) use multiple roller-wheel controls and switch controls (U.S. Pat. No. 6,307,465). U.S. Pat. No. 5,095,303 to Clark et al. (1992) uses three roller-wheel controls and a rolling belt that engages another roller-wheel control. U.S. Pat. No. 6,184,869 to Harding et al. (2001), U.S. Pat. No. 5,561,445 to Miwa et al. (1996), and U.S. Pat. No. 5,477,237 to Parks (1995) use multiple trackballs or roller-wheel controls. U.S. Pat. No. 6,115,028 to Balakrishnan et al. (2000), U.S. Pat. No. 6,075,521 to Sugiyama (2000), U.S. Pat. No. 5,973,669 to Fitzmaurice et al. (1999), and U.S. Pat. No. 5,706,028 to Murakami et al. (1998) use a magnetic tablet and multiple magnetic coils. U.S. Pat. No. 5,619,231 to Shouen (1997) uses a four-facet bottom each having a 2-D motion control. U.S. Pat. No. 5,754,168 to Maynard, Jr. (1998) uses a two-faceted or four-faceted bottom, where on each facet there is a depressible button, so that it effectively adds two or four additional switch controls. U.S. Pat. No. 5,910,798 to Kim (1999) adds four fine-movement buttons to a basic-type mouse. U.S. Pat. No. 6,456,275 to Hinkley et al. (2002) and U.S. Pat. No. 5,555,894 to Doyama et al. (1996) add multiple sensors on the body and on top of primary switch controls of a basic-type mouse. U.S. Pat. No. 5,122,785 to Cooper (1992) added squeeze sensors to a basic-type mouse.

There are other prior-art multi-functional pointing and control devices that are essentially based on the same idea but with some variations. U.S. Pat. No. 5,784,052 to Keyson (1998) adds a depressable trackball control to a basic-type mouse. U.S. Pat. No. 5,530,455 (1996) and U.S. Pat. No. 5,446,481 (1995) to Gillick et al. adds a depressable roller-wheel control to a basic-type mouse. U.S. patent application Ser. No. 09/843,794 of McLoone et al. (2002) and U.S. patent application Ser. No. 10/184,000 of Ledbetter et al. (2003) add slidable and tiltable roller-wheel controls to a basic-type mouse. These designs have a common problem, namely, they are difficult to use: rolling a roller-wheel control or trackball while keeping it depressed at a required level or tilted at a required angle, or keeping a side button depressed, all require considerable effort and concentration. U.S. patent application Ser. No. 09/045,463 of Wojaczynski et al. (2001) combines pressing special keys on the keyboard, such as ctr, or ctr/alt, with a mouse movement to control the scroll. This design requires pressing and holding special keyboard keys while moving the pointing device simultaneously, thus requiring use of both hands. It also requires a systematic redesign of the device drivers of the pointing device and the keyboard, so that they can operate jointly. Furthermore, distinguishing the scroll command from the normal keyboard functions of these special keys is a problem. U.S. Pat. No. 5,633,657 to Falcon (1997), U.S. Pat. No. 5,374,942 (1994) and U.S. Pat. No. 5,313,229 (1994), both to Gilligan et al., disclose a mouse with a scroll function based on a dominant axis analysis method. In these designs, switch controls (U.S. Pat. No. 5,633,657) or a thumb lever (5,374,942 and 5,313,229) generate the scroll (amount and speed) signals, while the most recent mouse movement signals are analyzed to determine the dominant axis for scrolling directions. However, the dominant axis analysis method has a severe functional problem, namely, the scroll occurs only in one direction (along the dominant axis) at any step. When a user intends to scroll diagonally, hence, he or she moves the mouse along a diagonal path, the actual scroll is either vertical or horizontal, depending on which direction the mouse has the relatively greater movement (the dominant axis). In order to scroll diagonally, a user has to constantly adjust the movement of the mouse in a zigzagged fashion in order to alternate the dominant axis, and the resultant scroll is at best of a zigzagged type. In practical use, a user constantly feels that the scrolling is incongruous with the movement of the mouse. Furthermore, the dominant axis analysis method requires processing and analyzing movement signals and scroll signals at every step, and users have to control both the motion control and the thumb lever (or button) simultaneously.

Although these prior-art designs differ from each other in the choices of controls and detailed structure, they are based on the same concept, which is to use secondary motion controls and secondary switch controls for additional functions. Such approach to multi-functional control suffers from a number of disadvantages:
1. Functions require their own controls, thus limiting the total number of functions.
2. Controls and functions are tied together, hence, the pointing and control devices are not versatile.
3. The complexity and parts increase dramatically with the increase in the number of functions, hence, reliability is predictably low, and the manufacturing cost is predictably high.
4. The pointing and control devices become too bulky and heavy.
5. The control signals are processed separately by separate signal-processing channels, hence, the signal-processing load increases dramatically with the increase in the number of functions.
6. Expanding the capability, i.e., adding functions, is difficult and has significant impact on other components, to the point of requiring a complete redesign of the system.
7. The exterior of the pointing and control device is complex and crowded, thus becoming ergonomically deficient.
8. The pointing and control device with large number of controls is confusing to most users and difficult to use in any case.
9. Various controls compete for positions, and some of them must be put in places that are relatively difficult to reach or operate.
10. User has to avoid other controls while operating a control.
11. User has to move their hands and change hand postures in switching from one control to another.
12. The operational mode (sliding, rotating, turning, tilting, etc.) of the controls may vary, thus forcing the user to switch from one mode to another.
   Last, but not the least, recall that the primary motion control, especially that of a computer mouse, generally provides more accurate and larger-range control, and it is easier and more natural to use than any secondary control, which often suffers from some restrictions due to position and other limitations. The reason that the computer mouse is by far the most popular pointing and control device is mainly due to the operability and usability of its primary motion control. Most of the secondary motion controls are operated by fingers. Such operations require repetitive finger curling (or extension) and repositioning, and are much more difficult than just sliding a computer mouse on a desk. Prolonged operations of that sort can cause fatigue, stress, and even permanent repetitive stress injury (RSI).

Although prior-art designs may allow a user to operate several or even all controls simultaneously, in practice it would be very difficult or even impossible for most people to perform such multiple tasks simultaneously (for example, operating a trackball while sliding the pointing and control device). As a result, most people would be able to operate only one control at a time, and alternate inefficiently among different controls.

In summary, there is a need for a multi-functional pointing and control device that overcomes such aforementioned disadvantages of prior-art designs.

### BACKGROUND OF INVENTION—OBJECTIVES AND ADVANTAGES

The present invention overcomes all aforementioned disadvantages of the prior-art multi-functional pointing and control devices, and it also offers several additional advantages. The major objectives and advantages of the present invention are:
1. to provide a general and unified method of multi-functional control that is versatile and efficient, requires fewer components, can easily support a large number of functions, and allows an easy expansion of capability;
2. to provide a general and unified method of multi-functional control that can be applied practically to any prior-art basic-type or multi-functional pointing and control device, as to increase its capability, simplify its structure, reduce its signal processing load, and improve its usability, while the remaining parts are adopted with little or no modification;
3. to provide a multi-functional pointing and control device that provides accurate and large-range control consistently for all functions;
4. to provide a multi-functional pointing and control device that has a simple exterior without crowded controls, hence leaving more room to ergonomic and other considerations;
5. To provide a multi-functional pointing and control device that has a simpler internal structure and uses fewer parts, hence, is more reliable and less expensive to produce;
6. to provide a multi-functional pointing and control device that requires less signal processing and data transmission, hence, is more efficient;
7. to provide a multi-functional pointing and control device that is intuitive and easy to use;
8. to provide a multi-functional pointing and control device that allows users to control all functions in a unified simple manner;
9. to provide a multi-functional pointing and control device that allows users to maintain an optimal hand posture and position at all times;
10. to provide a multi-functional pointing and control device that is programmable and allows a user to select and group the functions that he or she needs.
   Further advantages will become apparent from the following descriptions and drawings.

### SUMMARY

The present invention provides a general and unified method for multi-functional control. The fundamental idea of the present invention is to share the controls among the functions so that a small number of controls can support a large number of desirable functions. The approach of the present invention is to use a mode-selection means that allows a user to select a mode, where each mode corresponds to a subset of functions. Once a mode is selected, all controls are available and become dedicated controls for the functions belonging to the selected mode. This is opposite to the concept upon which the prior-art designs are based, where secondary motion controls (roller-wheel control, joystick, trackball, etc.) and secondary switch controls are used for additional functions. The present invention overcomes all aforementioned disadvantages of the prior-art multi-functional pointing and control devices and has several additional advantages. The present invention can be applied to almost all prior-art basic-type and multi-functional pointing and control devices to increase their capability, simplify their structures, reduce their signal processing loads, and improve their usability.

### DRAWINGS—FIGURES

In the drawings, closely related figures have the same number but different alphabetic suffixes.

FIG. 1-A shows an elevation view of a multi-functional pointing and control device with a sequential mode-selection means.

FIG. 1-B shows an elevation view of a multi-functional pointing and control device with a randomly accessible mode-selection means.

FIG. 2 shows a schematic block diagram of the internal structure of a multi-functional pointing and control device.

FIG. 3-A shows the internal structure of an exemplary sequential mode-selection means.

FIG. 3-B shows the internal structure of an exemplary randomly accessible mode-selection means.

FIG. 4 shows a schematic block diagram of the internal structure of a prior-art two-wheel mouse.

FIG. 5 shows the structure of the wheel of a typical prior-art roller-wheel control.

FIG. 6-A shows the structure of the wheel of a one-level mode-selection means.

FIG. 6-B shows the structure of the wheel of a two-level mode-selection means.

FIG. 6-C shows the structure of the wheel of another one-level mode-selection means.

FIG. 6-D shows the structure of the wheel of another two-level mode-selection means.

FIG. 7-A shows a schematic block diagram of the internal structure of a two-mode multi-functional pointing and control device.

FIG. 7-B shows a schematic block diagram of the internal structure of a six-mode multi-functional pointing and control device.

### DETAILED DESCRIPTION—PREFERRED EMBODIMENT

The present invention can be applied to almost any basic-type pointing and control device, such as a mouse, a trackball, a touch pad, a joystick, a sensor tablet, etc., converting it into a multi-functional pointing and control device. Construction of a multi-functional pointing and control device from a basic-type mouse will be used as an example.

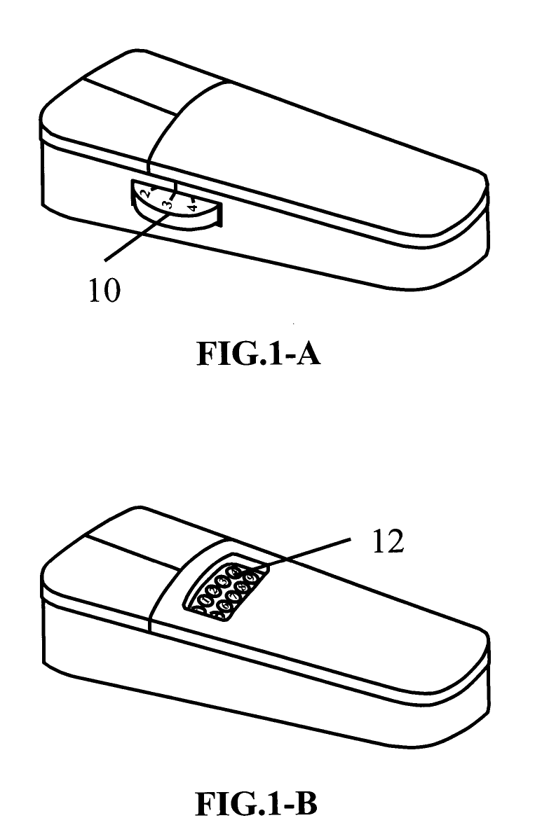

FIG. 1-A is an elevation view of the multi-functional pointing device of the present invention with a sequential mode-selection means. This is essentially a basic-type mouse with an additional mode-selection means. This mode-selection means has a thumb wheel 10 with multiple stops, each corresponding to a mode. For simplicity, the modes are labeled numerically. The label aligned with the indicator (a line) indicates the selected mode (mode 3 in FIG. 1-A). The thumb wheel 10 can be turned in both directions, and the mode-selection means generates a distinct mode-selection signal corresponding to each stop (mode). A user may have to pass through several modes to get to the desired mode (sequential selection). FIG. 1-B is an elevation view of the multi-functional pointing device of the present invention with a randomly accessible mode-selection means. The mode-selection means has a keypad 12 with ten keys. Again for simplicity, the keys are labeled numerically. If each key is mapped to a mode, the mode-selection means can have ten modes. If a unique combination of key depressing (for example, 128) maps to a certain mode, just like selecting a cable TV channel with the numerical keypad of a remote control, the number of modes is practically unlimited. This mode-selection means allows a user to jump from one mode directly to any other (randomly accessible).

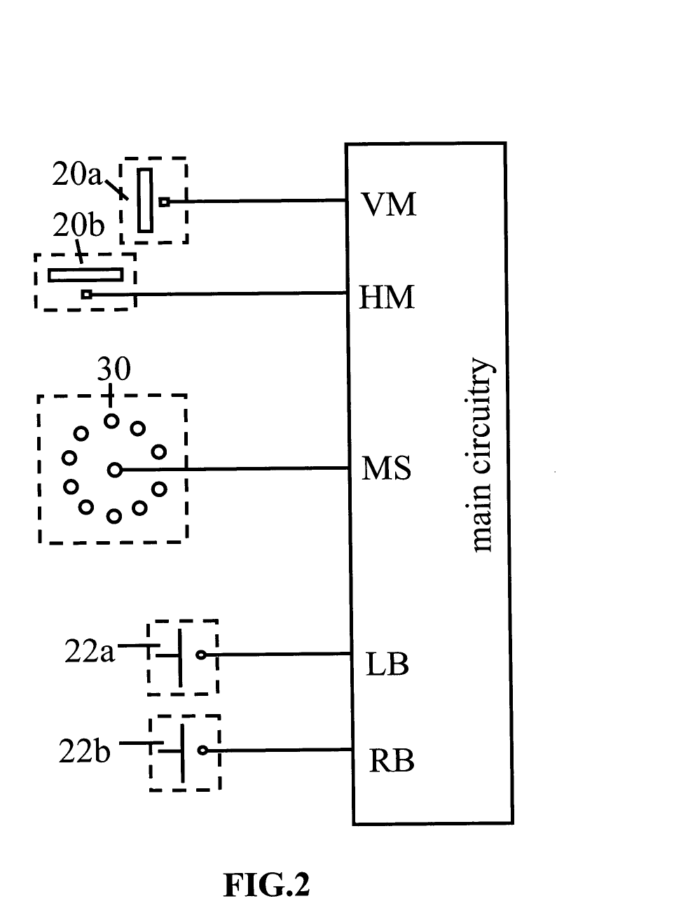

FIG. 2 is a schematic block diagram of the internal structure of the multi-functional pointing and control device of the present invention. The system has four major components: (1) a set of two switch controls 22a and 22b; (1) a 2-D motion control that actually consists of a vertical motion control 20a and a horizontal motion control 20b; (3) a mode-selection means 30; and (4) a main circuitry. It is to be understood that each component block includes the necessary parts and circuitry. It is also to be understood that in the schematic block diagrams, each connection shown may contain multiple physical connections.

The two switch controls 22a and 22b have on and off states and are connected to the signal-processing channels LB, which stands for left button, and RB, which stands for right button, respectively. The vertical motion control 20a and horizontal motion control 20b each generates a bi-directional motion-control signal. The vertical and horizontal motion-control signals are inputted to the signal-processing channels VM, which stands for vertical motion, and HM, which stands for horizontal motion, respectively. In some motion controls, each of the bi-directional motion signals actually consists of two pulse trains shifted in phase. The direction of the motion is determined from the phase shift, and the amount of motion is determined from the number of pulses. The mode-selection means 30 is capable of generating a set of distinct mode-selection signals, each corresponding to a mode. The mode-selection signals are inputted to the signal-processing channel MS, which stands for mode selection. The mode-selection signal can be a one-time signal that is generated momentarily when a mode is selected, or a persistent signal that persists until the next mode is selected (examples of both cases will be given later). The original mode-selection signal can be of any type (mechanical, acoustic, electric, magnetic, light, etc.) and is converted into an electric signal before feeding to the channel MS. Voltage, current, duration, frequency, phase shift, number of pulses, waveform, the input channel in circuit, or any other means can be used to identify a mode (examples of using voltage, number of pulses, and input channel for mode identification will be given later). With all these choices, together with hardware variations, there are countless ways to construct the mode-selection means. The main circuitry includes a microprocessor and a communication link (cable or wireless) to the computer. The main circuitry processes switch-control signals and converts them into switch-control data (for example, binary 1 represents on and binary 0 represents off). It also processes the two sets of bi-directional motion-control signals and converts them into motion-control data (usually in the form of signed count). It further processes the mode-selection signals and converts them into mode-selection data (preferably, the conversion of a persistent mode-selection signal is performed only once when a mode is selected). With regard to sending the data to the computer, there are generally two ways:
(1) the switch-control data, motion-control data, and mode-selection data are all sent to the computer;
(2) only the switch-control data and motion-control data are sent to the computer, but with an identification tag based on the mode-selection data.
   Neither the mode-selection data nor the tag is large. For example, a three-bit binary can be used to identify eight modes, which is probably more than enough in most practical applications.

The device driver identifies the selected mode from the mode-selection data or from the identification tag, and uses the control data for the functions belonging to the selected mode. In the case that the mode-selection signal is a one-time signal and the corresponding mode-selection data is sent only once, the selected mode needs to be stored for reference until a new mode is selected.

The device driver further implements a multi-mode mapping between the controls and the functions. In each mode, the controls map to a subset of functions. In general, the mapping between the controls and functions is a many-to-many mapping. A function may require several controls, and conversely a control can map to several functions so that these functions (or parts of them) are controlled simultaneously or synchronized. In addition, a function may exist in several modes for user convenience. It is preferable that closely related functions are grouped in the same mode. The device driver may have a set of case-branch statements (or equivalents). Each of them corresponds to a specific mode and includes the corresponding actions to be taken (for the functions belonging to that mode). Upon receiving any switch-control data or motion-control data, the device driver locates the case-branch statements corresponding to the selected mode, and uses the switch-control data and the motion-control data as input parameters for the corresponding actions. The actual codes that carry out the detailed actions may reside in the computer operating system or in an application program, typically in the form of a function or subroutine. In that case, the device driver simply calls that function or subroutine and passes the switch-control data and the motion-control data as parameters. When the computer is turned on, the mode-selection means may be left in any mode from previous use. In the case that the mode-selection signal is a one-time signal, the mode is unknown initially. The device driver may assume a default mode, for example, the usual vertical and horizontal cursor movement mode, until the user selects a mode. The default mode can also be assumed when the selected mode may not be determined due to error.

Two major distinctions separate the present invention from the prior-art designs. Distinction 1 is that with the present invention each control (motion or switch control) can be used for a different function in a different mode. If the number of modes is N, the present invention effectively increases the capability (if measured by the number of functions) of a basic mouse by N times. This is in sharp contrast with the prior-art approach to multi-functional pointing and control devices. Without sharing of controls, the same capability would require N 2-D motion controls (or 2N 1-D motion controls) and 2N switch controls and 4N separate signals channels to process the 4N sources of signals and transmit them to the computer. Distinction 2 is that with the present invention, in each mode all controls are available and are dedicated to the functions belonging to that mode. It is like having a dedicated pointing and control device for each mode. The motion-control signals and switch-control signals are automatically and exclusively used for the functions belonging to that mode, without requiring any different or additional user action. Without the mode change concept and mechanism of the present invention, all the controls are tied to fixed functions (cursor movement and item selection, for a basic mouse), and in order to force the control signals for any other purpose, another persistent indication (signal) is required. For that reason, when a user wants to use a basic-type mouse to move an object, he or she has to resort to a dragging action, namely, holding down a switch control (to provide the additional persistent indication or signal) while moving the mouse, during the entire process. This is also the reason that forces some prior-art multi-functional pointing and control devices to require users to hold down one or several switch controls, or several keyboard keys, or keeping a motion control depressed or tilted at a certain angle, while operating a motion control. Those kinds of operations are difficult and may require use of both hands. Furthermore, there is an additional signal to process. It must be emphasized that the present invention makes all controls, not just some of them, available and dedicated to the selected mode. This not only maximizes the use of all controls but also provides maximum control in each mode.

In practice, each user usually uses only a subset of the available functions that are pertinent to his or her specific work. The mapping may be alterable, namely, a user can select a desired set of functions and customize the mapping to suit his or her needs. Even if a user wants to keep all available functions, he or she still can customize the mapping for convenience. This is particularly useful with a sequential mode-selection means. A graphical configuration interface may be provided that allows a user to add functions to and remove functions from each mode. It is logical and convenient to group the similar and related functions into same mode. Such versatility does not exist in the prior-art multi-functional pointing and control devices where the controls are tied to specific functions.

Instead of numerical labels, more descriptive abbreviations and symbols may be used to label the modes of a mode-selection means. Or, a mapping table (alterable if programmable) between the numerical mode labels and the functions may be provided on top of the multi-functional pointing and control device. Also, a LCD may be used to display the selected mode and a brief description.

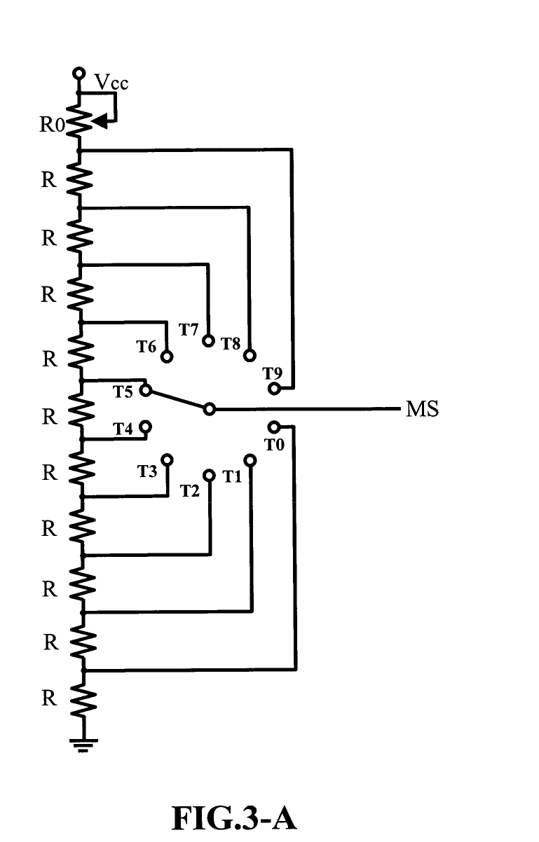

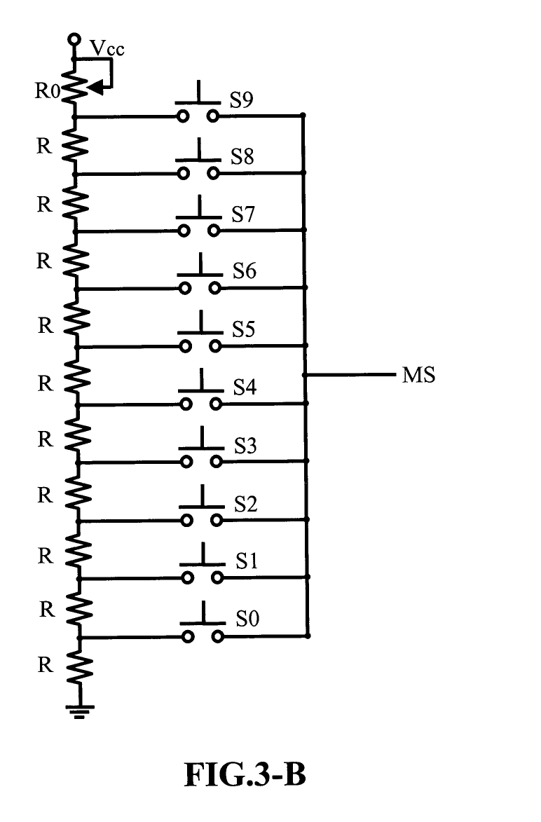

Now refer to FIG. 3 for the internal structure of an exemplary sequential mode-selection means. This example uses different voltages for mode identification, and the mode-selection signals are persistent signals. This mode-selection means has a total of ten modes. It comprises a switch with ten terminals labeled T0 through T9, each corresponding to a mode. There are ten identical fixed resistors R and a variable resistor R₀ connected in series. One end of the series is connected to a positive voltage V_{cc} and the other end is grounded. The variable resistor R₀ is used to control the current and hence the voltage drop across each fixed resistor. Assuming the voltage drop across each fixed resistor is 0.5 V, then the voltages at T0, T1, through T9 are 0.5 V, 1.0 V, through 5.0 V, respectively. At any time, the switch connects one of the ten terminals to the signal-processing channel MS, so that the mode-selection signal has a constant voltage, corresponding to the connected terminal. The signal-processing channel MS converts the mode-selection signal into a four-bit mode-selection data according to a ranged mapping: 0.25 V to 0.74 V maps to 0001 (binary), 0.75 V to 1.24 V maps to 0010, 1.25 V to 1.74 V maps to 0011, etc. The ranged mapping eliminates possible error due to voltage fluctuations. This mapping rule can be extended beyond the highest voltage range (4.75 V to 5.24 V) for possible further expansion.

With the present invention, adding a mode to the multi-functional pointing and control device of the present invention has little impact on the system. It requires (1) adding a mode to the mode-selection means and (2) adding corresponding case-branch statements in the device driver. With the above exemplary mode-selection means, adding a mode to it amounts to adding an identical fixed resistor R and a corresponding switch terminal, and reducing the resistance of the variable resistor by that of the fixed resistor. With the prior-art approach, the equivalent would require (1) adding two secondary switch controls and one secondary 2-D (or two 1-D) motion control, (2) adding four separate signal processing channels (which requires a re-design of the circuitry and may require a more powerful microprocessor), (3) adding corresponding case-branch statements in the device driver.

Now refer to FIG. 3-B for the internal structure of an exemplary randomly accessible mode-selection means. This mode-selection means is modified from the previous sequential mode-selection means shown in FIG. 3-A. Now each terminal is connected to the signal-processing channel MS through a push-button switch (labeled S0 through S9). If at any time only one switch remains connected (connecting a switch causes the previously connected switch to disconnect), the mode-selection means can support ten modes. The corresponding mode-selection signals are persistent signals, and different voltages are used for mode identification. If the switches are momentary switches (which connect when depressed and disconnect when released) and each mode is identified by a distinct sequence of switch depressing (similar to using a TV remote control keypad to select a channel), the mode-selection means can support practically unlimited number of modes. In this case, the mode-selection signals are one-time (temporary) signals and the waveform is used for mode identification. However, the waveforms do not have to be of strict forms, as long as a sequence of different voltages shows up within a predetermined period of time. With such a mode-selection means, adding a new mode only requires adding corresponding case-branch statements in the device driver.

These exemplary mode-selection means are chosen because of their simplicity (in illustrating the concept) rather than because of their properties. Obviously, they can be modified or improved in many respects. For example, the resistors may be replaced by capacitors so that there would be no constant current drain to the ground. It will be appreciated by the skilled in the art that many other structures can be used for mode-selection means, as long as they are capable of generating a set of distinct signals.

Regardless of the number of functions, the multi-functional pointing and control device of the present invention always has a simple structure, which is essentially a basic-type pointing and control device plus a mode-selection means. The exterior design can be left completely to ergonomic considerations, i.e., to provide the optimal operation position and posture for the user's hand. The multi-functional pointing and control device of the present invention allows a user's hand to remain in that optimal position and posture at all times, since the user no longer has to switch from one control to another for different functions.

As mentioned earlier, the motion control of a computer mouse provides more accurate and larger-range control than any other type of existing motion controls. Since this motion control is used for all functions, the present invention provides accurate and large-range control consistently and uniformly for all functions.

Furthermore, with the present invention, there are always only three types of signals to process, namely, the switch-control signal, the motion-control signal, and the mode-selection signal, regardless of the number of functions. So, the present invention uses fewer parts, simpler circuitry, and requires less signal processing and data transmission. Because of its simplicity and efficiency, the multi-functional pointing and control device of the present invention can easily support more functions than any prior-art multi-functional pointing and control devices. A multi-functional pointing and control device that supports a large number of functions is quite advantageous, since it could be used with many types of equipment.

### Operation

The multi-functional pointing and control device of the present invention is easy to use: a user simply selects any desired mode and slides the device on the desk (left-right, back-forth) and use the switch controls to control the functions belonging to the selected mode. Consider the following modes, for example.
1. x-y motion of cursor: when this mode is selected, left-right and back-forth motion cause the cursor on the display to move along the x-axis and y-axis, respectively.
2. vertical-horizontal scroll of image: when this mode is selected, left-right and back-forth motion cause a selected image on display to scroll horizontally and vertically, respectively.
3. fast x-y motion of cursor: same as mode 1, but at a faster speed than mode 1.
4. Fast vertical-horizontal scroll of image: same as mode 2, but at a faster speed than mode 2.
5. x-y translation of a selected object: when this mode is selected, left-right and back-forth motion cause the selected object on the display to move along the x-axis and y-axis, respectively.
6. x-z translation of a selected object: when this mode is selected, left-right and back-forth motion cause the selected object on the display to move along the x-axis and z-axis, respectively.
7. x-y rotation of a selected object: when this mode is selected, left-right and back-forth motion cause the selected object on the display to rotate about the x-axis and y-axis, respectively.
8. x-z rotation of a selected object: when this mode is selected, left-right and back-forth motion cause the selected object on the display to rotate about the x-axis and z-axis, respectively.

For each mode, the switch controls can provide additional control. For example, in cursor motion modes (mode 1 and 3) the switch controls are used for usual item selections. In image scroll modes (mode 2 and 4) the switch controls can be used to control the so-called constant-speed scroll (also called power scroll or momentum scroll). For example, a single click of the first switch control and the second switch control starts, respectively, upward and downward scroll at a constant speed, a double click of the switch controls starts the scrolls at a faster speed, and a single click of any switch control or any movement of the motion control stops the on-going constant-speed scroll. Without the mode-change concept and mechanism of the present invention, the prior-art designs (for example, U.S. Pat. Nos. 6,166,721 and 5,633,657) require additional switch controls, because their primary switch controls are tied to their own functions (selecting items, starting a program, etc.). In the object-manipulation modes (5 to 8) the switch controls can be used to select an object. Preferably the cursor changes form (or disappears if not needed) for different modes.

The eight modes discussed above are selected for illustrative purpose only. The first two modes support vertical and horizontal cursor movement and image scroll, which are sufficient for ordinary computer users. Mode 3 and 4 provide the same functions but at a higher speed, further improving the usability. The last four modes allow users to control all six degrees of freedom of any solid object in a CAD-type application. Notice that x-translation and x-rotation are provided by two different modes for the user's convenience.

The cursor movement and scroll speed can be altered inside the multi-functional pointing and control device (for example, using multipliers/dividers) or in the device driver (using different speed ratios, or, preferably, using different acceleration curves), as is well known in the art. It should be emphasized that although various speed control mechanisms have been introduced in prior art, their use differs considerably from that of the present invention. The differences again stem from the fundamental difference that exists between the present invention and prior-art designs. With the prior-art designs, a speed control alters only the signals of a specific motion control, hence, each motion control requires its own speed control. With the present invention, a common speed control is used to alter the motion-control signals (or motion-control data), and that effectively controls the speeds for all modes. Another difference is that in the present invention different speeds are treated as different modes, they are controlled, as all other modes, by the same mode-selection means, thus requiring no additional button or wheel.

The use of the multi-functional pointing and control device of the present invention is very intuitive for the user, and the motion of the object on the display correlates naturally with the motion of the device operated by the user. For example, in scroll modes, as a user moves the pointing and control device towards a hidden part of the image, the hidden part is brought into the display area. The pointing and control device of the present invention thus allows a user to control all functions with one consistent and uniform type of motion, as oppose to having to change from one type to another.

Making all controls available and dedicate to the selected mode (with a set of closely related functions) can avoid some unpleasant accidents that could occur with the prior-art designs. For example, in the above scroll mode a user was sliding the device to scroll through a document (distance scroll) and the user accidentally depressed a switch control and the constant-speed scroll started. Because the user was concentrating on the scroll so he or she immediately noticed the change and could decide either to stop the constant-speed scroll or let it continue. While with a prior-art multi-functional pointing and control device, the controls may correspond to very different functions. When a user is operating a specific control to control a specific function, an accidental activation of another control may cause a change of a totally unrelated function. Since the user is concentrating on the current function, he or she may not notice the accident, which could cause unexpected and frustrating results later. The present invention adheres to this principle, even in the case that some controls are not needed in a certain mode. In such case the device driver simply ignores the control data from these unneeded controls, so effectively they are disabled.

### DETAILED DESCRIPTION—ALTERNATIVE EMBODIMENTS

The preferred embodiment teaches how to construct a multi-functional pointing and control device from a basic computer mouse based on the fundamental idea of the present invention. The present invention can also be applied to almost all prior-art multi-functional pointing and control devices to increase their capability, simplify their structures, reduce their signal processing loads, and improve their usability. Two types of such application will be introduced in the following, with the common aim to eliminate some or all secondary controls while adopting the remaining components with as little modification as possible. This goal is of great economic importance. Given the existing limitations of the prior-art multi-functional pointing and control devices, the embodiments that are about to be described are quite specific and may have some limitations. However, it should be understood that these specific limitations must not be construed as inherent limitations of the present invention.

It is impossible to describe in detail the structure and working principle of every individual prior-art multi-functional pointing and control device, hence, how the present invention could be applied to that device in particular. Therefore, the case of a two-wheel mouse is chosen to illustrate the two types of application. For definiteness, it is also assumed that the two roller-wheel controls are for the vertical and the horizontal image scroll, respectively. Although roller-wheel controls are quite popular, they are far from ideal. First of all, operating a roller-wheel requires repetitive finger curling (or extending), lifting, and repositioning. Prolonged use of a roller-wheel can cause fatigue, stress, and even permanent repetitive stress injury to user's hand. Secondly, since a user has to reposition his or her finger after each turning of the wheel, the image scroll is not continuous, but rather intermittent. Thirdly, it is very difficult to operate two roller-wheel controls simultaneously, for example, to perform diagonal scrolls. Finally, both wheels are usually mounted longitudinally, since a laterally rotating wheel would be physically difficult to operate. As a result of this arrangement, the motion of the horizontal-scroll roller-wheel control is rather incongruous with the corresponding longitudinal rolling on the device operated by the user. Applying the present invention to the two-wheel computer mouse solves all of these problems.

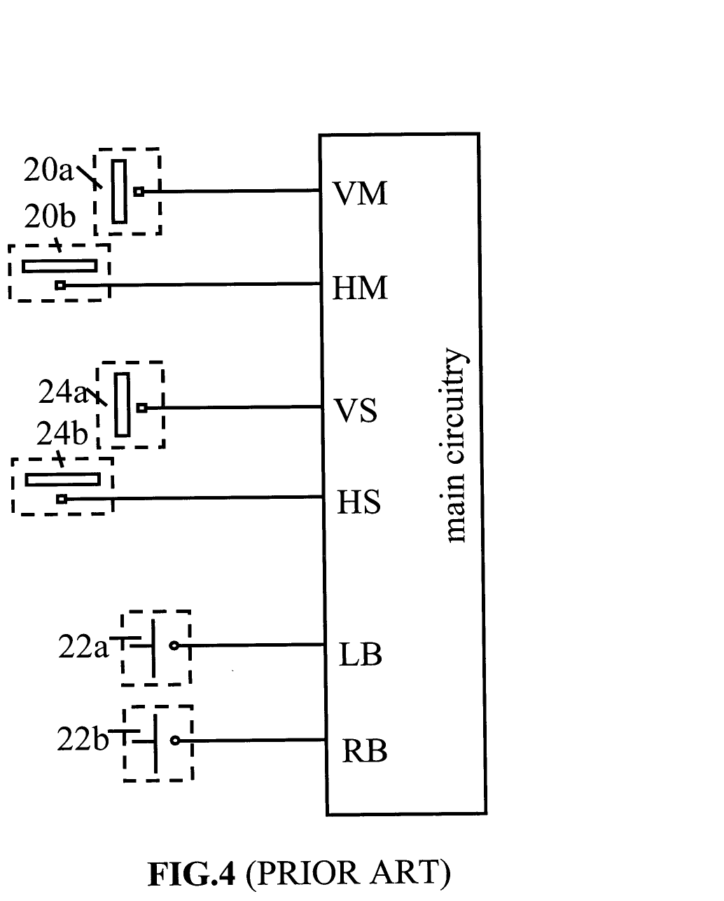

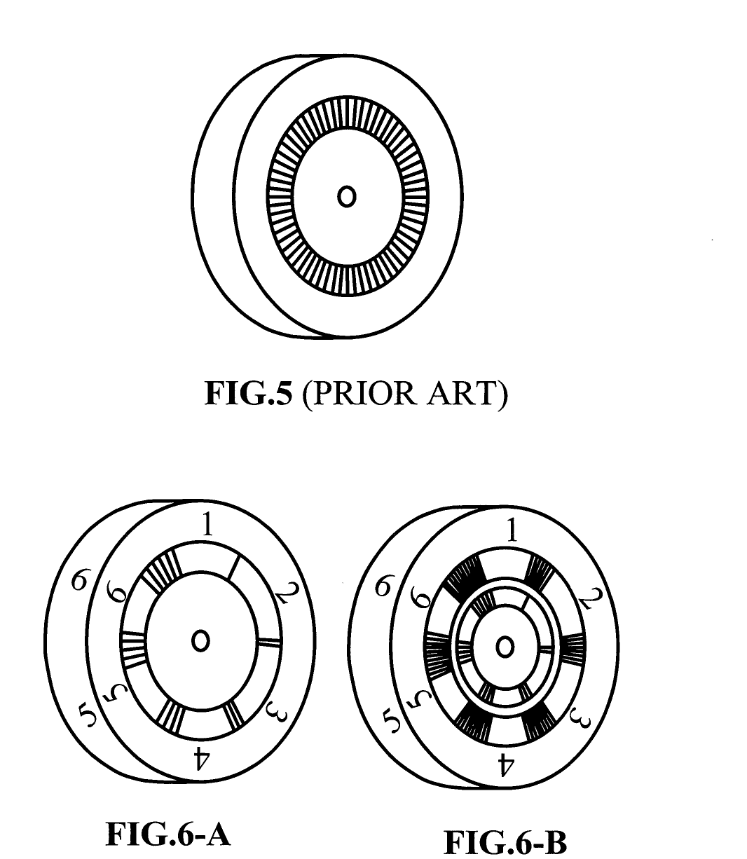

Now refer to FIG. 4 for the working principle of a typical prior-art two-wheel computer mouse. A two-wheel mouse is essentially a basic-type mouse, plus two secondary motion controls (roller-wheel controls) for additional functions (vertical and horizontal image scroll). It has four major components: (1) a set of two switch controls 22a and 22b; (2) a 2-D motion control that actually consists of a vertical motion control 20a and a horizontal motion control 20b; (3) a set of two roller-wheel controls 24a (for vertical image scroll) and 24b (for horizontal image scroll); and (4) a main circuitry. All other parts have already been explained, except for the roller-wheel controls. A roller-wheel control has a finger-operable wheel with a ring of uniformly spaced open slits, as shown in FIG. 5. It also has two light source/photodetector pairs (not shown), with the light sources and the photodetectors located on opposite sides of the wheel, such that the photodetectors receive light from their corresponding light sources through the open slits. When the wheel turns, each photodetector receives light intermittently and generates a pulse-train signal. The number of pulses equals the number of slits passed by, and the phase shift (due to the position shift of the two photodetectors) of the two pulse trains indicates the direction of the wheel rotation. Thus, a roller-wheel control essentially generates 1-D motion-control signals indicative of both the direction and the amount of the wheel rotation. The signals of the roller-wheel control 24a and 24b are fed into separate signal-processing channels, VS, which stands for vertical scroll, and HS, which stands for horizontal scroll, respectively. The main circuitry processes and formats the six sources of signals (two switch-control signals, two primary motion-control signals, and two roller-wheel control signals) separately, and sends them to the computer. The device driver identifies the six types of control data and uses them accordingly.

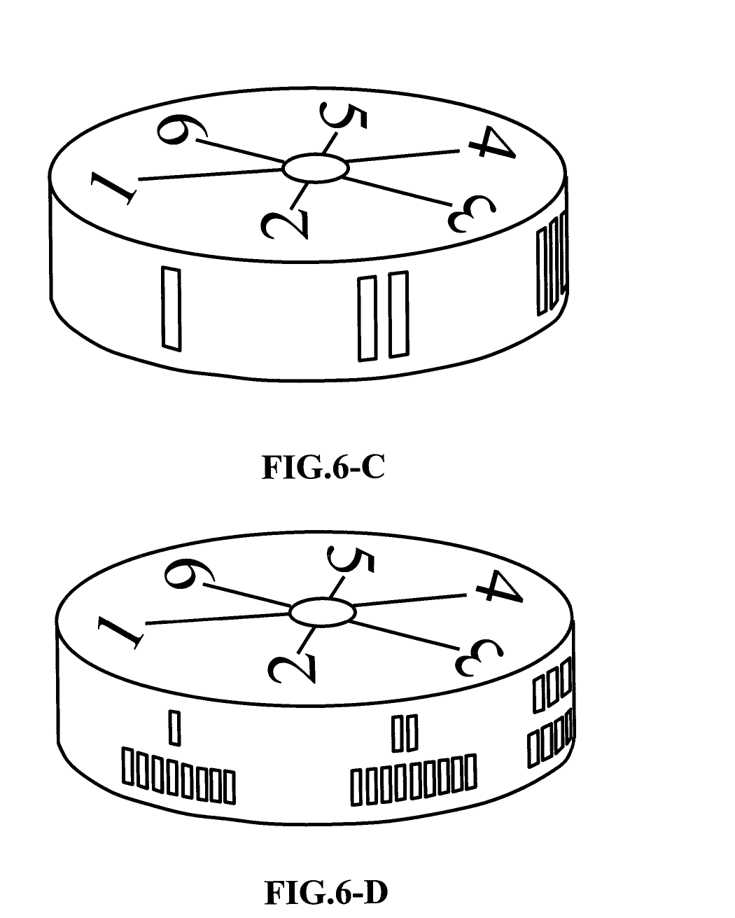

The first type of application of the present invention to a prior-art multi-functional pointing and control device is to convert one secondary control into a mode-selection means, and eliminate the rest of the secondary controls. For definiteness, the roller-wheel control 24b is eliminated and the roller-wheel control 24a is converted into a mode-selection means. FIG. 6-A shows the structure of the modified wheel. Unlike the prior-art wheel (FIG. 5), this modified wheel has only six stable stops, marked 1 to 6, corresponding to the six available modes, with a distinct number of slits between any two adjacent stops (the rest slits may simply be blocked). When this wheel is turned from one stop (mode) to the next one, the photodetectors generate a directional pulse train with a distinct number of pulses (equal to the number of slits between the two stops). This provides an example where the phase shift and the number of pulses are used for mode identification, and the mode-selection signal is a one time signal. The signal-processing channel VS converts the signals from the modified roller-wheel control, which is now the mode-selection means, into signed counts, as usual. In this example, a forward turn from stop n to n+1 (n=1, 2, 3, 4, 5) produces a signed count +n, while from stop 6 to stop it produces a signed count +6. Conversely, a backward turn from stop n+1 to stop n (n=1, 2, 3, 4, 5) produces a signed count −n, while from stop 1 to 6 it produces a signed count −6.

No other part of the one-wheel computer mouse is changed, and the main circuitry receives and processes all signals as usual, except that the horizontal scroll signals are no longer generated. The device driver is modified such that it uses the vertical scroll data for mode identification according to the following mapping: signed count +n (n=1, 2, 3, 4, 5) maps to mode n+1, signed count −n (n=1, 2, 3, 4, 5, 6) maps to mode n, and signed count +6 maps to mode 1. Therefore, with a limited number of stable stops and a distinct number of slits between adjacent stops, the roller-wheel control is effectively converted into a mode-selection means. Since the case-branch statements (or equivalents) that correspond to the original functions (vertical and horizontal cursor movement and image scroll) are already in place in the original device driver, the modifications on the device driver amount to no more than adding the mode mapping and the additional case-branch statements for the new functions.

In this example, a minimum number of slits are used for the sake of simplicity. However, any number of slits can be used, as long as each set has a distinct number of slits. For example, one may use five slits between stop 1 and 2, ten slits between stop 2 and 3, etc., plus a ranged mapping: a signed count between +3 and +7 maps to mode 2, a signed count between +8 and +12 maps to mode 3, etc. This arrangement eliminates the possibility of any mode-assignment error due to misread of a few pulses.

A typical roller-wheel usually uses an accumulator to accumulate the received pulses for a predetermined period of time. The mode-selection data may be chopped into partial data if this accumulation period is shorter than the time used to turn the mode-selection means from one stop to an adjacent stop. For example, a signed count +5 could become a signed count +2 plus a signed count +3, and are sent separately. The simplest solution to this problem is to extend the accumulation period or accumulate the mode-selection data in the device driver. However, the accumulation period should not be too large, since that may generate an over-accumulation of pulses (or signed counts), when the wheel is turned very fast and passes through several stops during the accumulation period. For example, +2 and +3 could then be incorrectly combined into +5. With a sensible choice of the number of slits and appropriate error-catching-and-fixing logic, the device driver can detect over-accumulation and determine the correct mode. Concentrated slits and mechanical structure that makes slits pass swiftly can also help. Should such error occur anyway, the driver would not be able to determine the selected mode, it would continue to assume the previous mode or the default mode. All that the user has to do is to turn the wheel to an adjacent mode and then back.

This mode-selection means can be modified slightly to accommodate more modes. As shown in FIG. 6-B, the wheel now has two rings of open slits, with a total of twelve distinct sets of slits, enabled by two operation levels (for example, up and down). The light source/photodetector pairs are fixed, namely, they do not move with the wheel. At each operation level, the light source/photodetector pairs engage a different ring of slits. Therefore, each stop corresponds to two modes, depending on which level the mode-selection means is operating. This modification doubles the number of modes. FIG. 6-C and 6-D show slightly modified one-level and two-level wheels. These wheels have a bottle-cap shape, with open slits on the sidewall. The same idea can be readily extended to further multiple levels.

An accumulated count of pulses can also be used for mode identification, whereby the forward and backward turnings of the wheel from one stop (mode) to an adjacent one contribute a positive and negative count of pulses to the accumulated count of pulses, respectively. The selected mode is determined by the remainder of the accumulated count divided by the total number of modes (modulus). A one-directional turning wheel is also an option.

In this application of the present invention, a two-wheel computer mouse (with normal basic mouse functions, plus vertical and horizontal scroll functions) is converted into a six-mode multi-functional pointing and control device. A user operates the roller-wheel control only to change modes, hence, the frequency and intensity of the roller-wheel operation is significantly reduced. Diagonal scroll no longer presents any problem, because all that a user has to do is to switch to the scroll mode and slide the device diagonally, quite congruently with the display. Obviously, a one-wheel mouse is actually more suitable for such conversion, since there would be no need to remove the second roller-wheel control.

An important characteristic of this application is that all other components remain intact, except for minor modifications on the wheel of a roller-wheel control and on the device driver. This type of application is more effective if one of the secondary controls can be relatively easily converted into a mode-selection means.

The second type of application of the present invention to a prior-art multi-functiona pointing and control device consists in eliminating all the secondary controls and using a hardware switch, which may include signal conversion elements, as the mode-selection means that selectively switches the primary control signals into different signal channels. In this type of application, signal input channels are used for mode identification. In the sense that the mode-selection means connects the controls to the selected signal channels until a new mode is selected, the mode-selection signals may be considered as persistent. Again, a two-wheel computer mouse will be used as an example to illustrate this method.

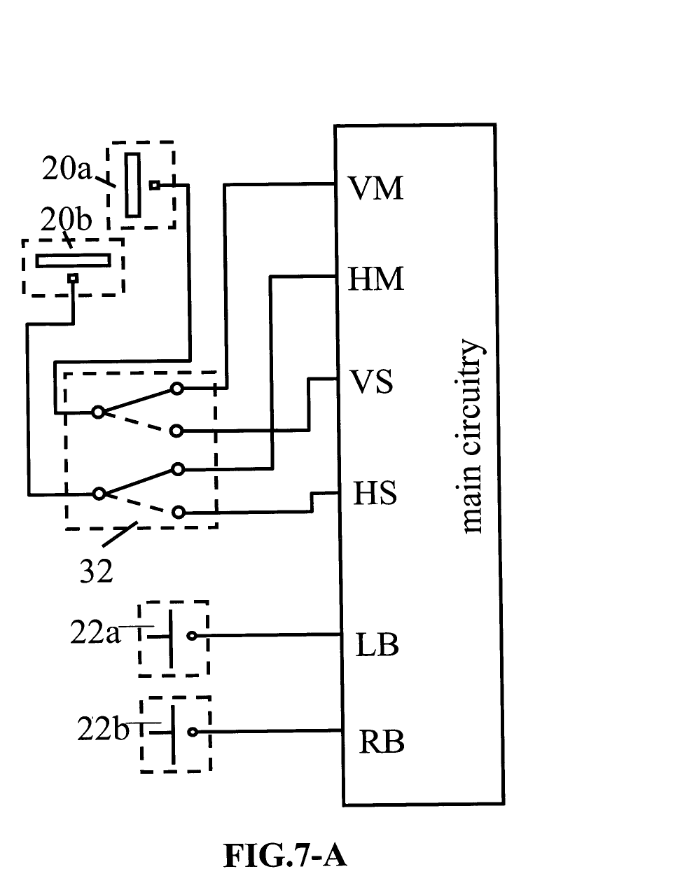

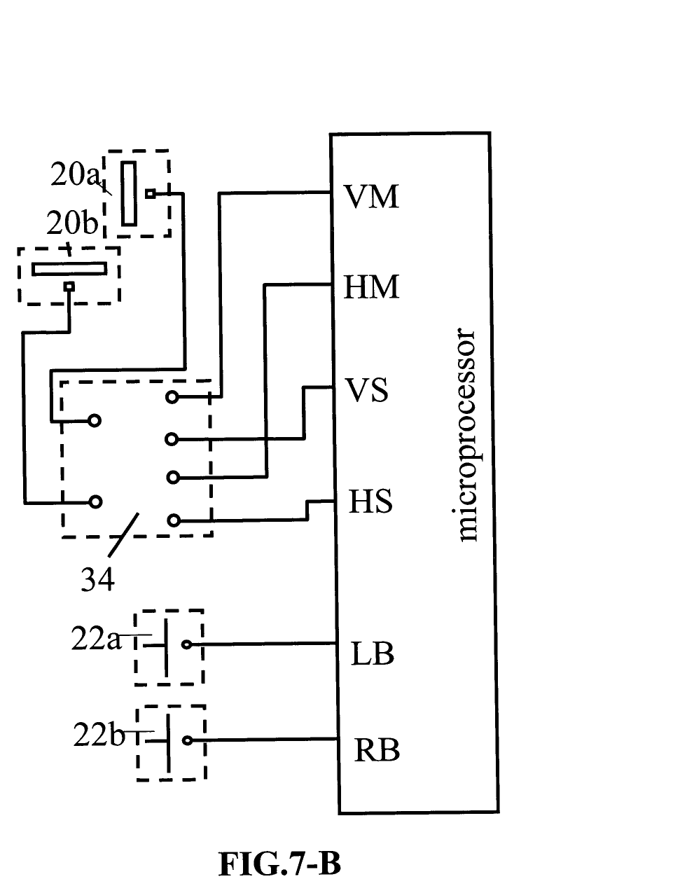

Now refer to FIG. 7-A for an example of the signal channel switching method. This embodiment is essentially the same as that of a two-wheel mouse, except that the two roller-wheels are removed and a mode-selection means 32 is added. The mode-selection means in this embodiment comprises of a two-state switch, with each state corresponding to a mode. In the first state (with switch connections illustrated by solid lines in FIG. 7-A), the mode-selection means sends the vertical and horizontal motion signals to their normal channels, VM and HM, respectively. Hence, in this mode, sliding the mouse on the desk causes the cursor to move on the display. In the second state (the switch connections are now illustrated by dotted lines in FIG. 7-A), the mode-selection means sends the vertical and horizontal motion signals to the scroll-signal channels, VS and HS, respectively. Hence, in this mode, sliding the mouse on the desk causes the image on the display to scroll. If the motion control produces the same type of signals as the roller-wheel controls, then the mode-selection means is simply a normal two-state switch. Otherwise, the mode-selection switch must include necessary signal conversion element for the second (scroll) state. Such signal conversion circuitry is well known in the art. As a general guideline, one should let the motion-control signal channels do as much the signal processing as possible and takes the signals at a strategic point such that the conversion is simplest.

Again, an important property of this example is that, beyond that of the mode-selection means (including the necessary signal conversion and rate change elements), there are no other modifications of any component. The microprocessor still receives cursor-motion and image-scroll signals from the respective channels, processes and sends them to the computer, as usual. The device driver remains unchanged, working as usual. In this exemplary embodiment, the original capability of a two-wheel mouse is retained. However, the present invention significantly simplifies its structure (two roller-wheel controls are replaced by a simple switch). Furthermore, both the cursor movement and the image scroll are controlled by the (primary) motion control with a unified and most comfortable action (sliding), thus improving considerably the usability of the device.

With some variations, the number of functions can be further increased. Now refer to FIG. 7-B for such an example: a prior-art two-wheel mouse is converted into a six-mode pointing and control device. Unlike the previous embodiment shown in FIG. 7-A, the mode-selection means 34 no longer switches the motion-control signals pair-wise, but it can selectively connect them to any two of the four terminals VM, HM, VS, and HS. Depending on which two channels receive motion-control signals, there are six distinct combinations: (1) VM and HM; (2) VM and VS; (3) VM and HS; (4) HM and VS; (5) HM and HS; (6) VS and HS. Each of these distinct combinations is used to identify a mode. Since the mode is identified by which two channels carry signals, a user must slide the mouse diagonally for an adequate distance after making a mode selection, so that both connected channels receive signals. Upon receiving the data, the device driver determines the selected mode based on the combination of data. The device driver stores the selected mode and uses subsequent data accordingly until it receives a new combination of data that is indicative of a new mode selection. Again, signal conversion and/or rate multiplier may be required for certain channels. This example also uses signal channels to identify modes, similar to the previous example of FIG. 7-A. For simplicity, one-channel, three-channel (such as vertical motion-control signals that are sent to two channels and horizontal motion-control signals that are sent to another channel) and four-channel combinations are not explicitly considered here. However, these combinations could produce even more modes. Evidently, a one-wheel mouse can also be used for this application, although with fewer available modes.

The mode-selection means could also switch the switch-control signals into different switch-control signal channels in addition to switching motion-control signals, if multiple switch-controls (more than two) exist, so that the switch controls are also shared by all modes (functions). One such example is the application of the present invention to a prior-art multi-functional pointing and control device with two primary switch controls and two secondary switch controls for constant-speed scroll. This type of application is most effective if the secondary motion controls are similar to the primary motion control, since that involves less or no signal conversion at all.

Conclusions, Ramifications, and Scope

The present invention promotes sharing controls (and signal-processing channels) among all functions, while prior-art multi-functional designs teach the opposite, namely, using separate controls and separate signal processing channels for different functions.

The present invention can be applied to almost any prior-art basic-type pointing and control device, such as a mouse, a trackball, a touch pad, a joystick, a sensor tablet, etc., converting it into a multi-functional pointing and control device. The present invention can also be applied to almost any prior-art multi-functional pointing and control device, increasing its capability, simplifying its structure, reducing its signal processing load, and improving its usability. In these applications, while removing some parts of the prior-art pointing and control devices, the present invention incorporates the remaining components with little or no modification.

Conversions of basic-type and two-wheel mouse into multi-functional pointing and control devices have been provided to illustrate how to apply the present invention to prior-art basic-type and multi-functional pointing and control devices. These embodiments should be regarded only as examples. These methods can be further combined and multiple mode-selection means can be used to provide even more modes for more sophisticated controls.

Several mode-selection means have also been provided and they also should be considered as examples only. Any control that is capable of generating a set of distinct signals can be used as a mode-selection means. The mode selection means does not have to be a mechanical control (with mechanical wheel, push-button switch, etc.) but can also be a sensor control. For example, the wheel-type mode-selection means in FIG. 1-A can be replaced by a sensor control, each activation switches the mode-selection means to the next mode. The push-button switches of the keypad in FIG. 1-B can also be replaced by sensor switch controls.

So far, in all the aforementioned exemplary embodiments, the mode-selection means are located on the pointing and control devices. This is the preferred configuration, since it allows a user to control all functions with one hand. Obviously, the present invention is not limited to such configuration, and a separate device may be used as the mode-selection means. For example, a distinct set of keystrokes on a keyboard can be used for mode identification. With the present invention, since a one-time (temporary) signal is sufficient to cause the mode change, a user is not required to hold down these keys during the entire operation. This is in sharp contrast with prior-art designs, where a user has to holding down a set of special keys, while operating the motion control.

Mode-selection means can also be provided by the switch controls or motion controls. For example, distinct sequences of clicks (repetitive clicks or combination clicks with one or two switch controls) or specific motion patterns can be used for mode identification. In this case, the controls also function as the mode-selection means, in addition to their normal functions. Another possible mode-selection means is a mode-selection menu or toolbar on the display. With such a mode-selection means, the usual x-y cursor motion mode is used as a default mode. When the computer starts up, the device driver assumes the default mode. In the default mode, the mode-selection menu or toolbar is displayed. When the user clicks the icon representing the desired mode, the device driver switches the pointing and control device to that mode, and the mode-selection menu or toolbar disappears (preferably, an icon is displayed on the screen to indicate the selected mode). For any of the non-default modes, a predetermined distinct sequence of switch control clicks or motion pattern causes the default mode to return, so that the user can select a new mode. Of course, this method is suitable to computers or any similar equipment with a display. With a mode-selection menu or toolbar, no additional hardware mode-selection means is actually needed.

The method of using a mode-selection menu with the present invention should not be confused with some existing features. For example, in some CAD-type application programs, when a user selects an object and a tool from a toolbar, several handles appear around the selected object. These handles can be dragged with a pointing and control device to manipulate (move, resize, rotate, etc.) the selected object. U.S. Pat. No. 5,396,590 to Kreegar (1995) and U.S. Pat. No. 5,019,809, respectively, suggest different versions of the same idea. Another example is found in word-processing and spreadsheet programs, where there are scrollbars in the form of icons. When a user clicks or drags a specific portion of a scrollbar, the displayed image (e.g., a document) is scrolled accordingly. U.S. patent application Ser. No. 09/812,754 of Davis et al. suggests a similar idea, although with more elaborate scroll features. The difference that has already been discussed (in distinction 2) with these prior-art methods is that a user has to make the switch control click in a specific area, or use a dragging type action.

In all exemplary embodiments and discussions, for the sake of simplicity, a basic model of the multi-functional pointing and control device of the present invention has been consistently used. This basic model has one mode-selection means, two switch controls, and one (2-D) motion control. The present invention is not limited to such basic model. Obviously, any number of switch controls and motion controls can be used with the present invention. With multiple switch controls (i.e., more than two) and motion controls (i.e., more than one), the multi-functional pointing and control device can support simultaneously even more functions in each mode, with all switch controls and motion controls available and dedicated to those functions. The capability of the multi-functional pointing and control device of the present invention is always N (number of modes) times of that of a prior-art multi-functional pointing and control device with same number and types of motion controls and switch controls. However, in most cases, one (2-D) motion control and two switch controls may suffice. Using more controls is not needed for capability, since that can always be achieved by having more modes, but it is rather a matter of convenience. One example is to use a pair of a coarse and a fine motion control. Again, with the present invention, the pair supports all modes (functions). Another example is to use a 2-D motion control and a roller-wheel control. In a first mode (normal mode), the 2-D motion control is used for cursor motion, and the roller-wheel control is used for (vertical) image scroll. In a second mode (object translation mode), the 2-D motion control is used for moving an object along the x-and y-axis, and the roller-wheel control is used for moving the object along the z-axis. In a third mode (object rotation mode), the 2-D motion control is used to rotate an object about the x-and y-axis, and the roller-wheel control is used to rotate the object about the z-axis. This “one-wheel mouse” has the same normal functions of a prior-art one-wheel mouse, plus controls for the six additional degrees of freedom of solid object.

Finally, the multi-functional pointing and control device may further have sensitivity controls, which control the response of the functions to the motion controls. Speed control for cursor movement and image scroll represents a particular form of sensitivity controls. The sensitivity controls can be hardware controls that modify the motion-control signals of some or all motion controls, or software controls that modify some or all motion-control data. With the present invention, a sensitivity control is shared by all functions.

The fundamental idea of the present invention can be used not only to control computers but also various other types of equipment, involving various controls that may not be limited to switch controls and motion controls. The present invention provides a general and unified approach to the multi-functional control rather than providing a specific design for a set of specific functions as the prior-art designs. The appended claims are intended to cover the fundamental idea and the spirit of the present invention. The scope of the present invention should be determined by the appended claims and their legal equivalents, rather than by the given examples.

1. A method for controlling a plurality of functions of a piece of equipment comprising the steps of:
(a) providing a plurality of controls, said controls being capable of generating control signals that are adequate to control each said function,
(b) providing a mapping with a plurality of modes, in each said mode said controls mapping to a subset of said functions and being used exclusively to control said subset of functions, said mapping being a many-to-many mapping,
(c) providing a mode-selection means that allows users to indicate a selected mode from all said modes,
whereby all said controls are available and are dedicated to said selected mode, whereby said controls are shared by said functions, whereby all said functions are controlled in a uniform and consistent manner, and whereby increasing the number of said functions does not require additional controls.

2. The method of claim 1 wherein said modes further include a default mode that is assumed when said selected mode could not be determined.

3. The method of claim 1 wherein said mapping is alterable, whereby users can customize said mapping.

4. The method of claim 1 wherein said mode-selection means is a hardware control that is capable of generating a set of distinct mode-selection signals, each said distinct mode-selection signal indicating a mode.

5. The method of claim 1 wherein said mode-selection means is provided by said controls, a predetermined distinct sequence of said control signals identifying a mode.

6. The method of claim 1 wherein a display is further provided and said mode-selection means is a mode-selection menu displayed on said display and allowing users to select a mode.

7. The method of claim 1 wherein a plurality of sensitivity controls are further provided that allow users to adjust the response of said functions to said controls.

8. A multi-functional pointing and control device to control a plurality of functions of a piece of equipment comprising:
(a) a plurality of controls, said controls being capable of generating control signals adequate to control each said function,
(b) a mapping with a plurality of modes, in each said mode said controls mapping to a subset of said functions and being used exclusively to control said subset of functions, said mapping being a many-to-many mapping where one said control can map to a plurality of said functions, one said function can map to a plurality of said controls and can exist in a plurality of said modes,
(c) a circuitry including a microprocessor and communication link to said equipment, said circuitry processing said control signals, formatting them into suitable forms, and communicating them with said equipment via said communication link,
(d) a mode-selection means that allows users to indicate a selected mode from all said modes, whereby all said controls are available and are dedicated to said selected mode, whereby all said functions are controlled by the same set of said controls in a uniform and consistent manner, and whereby said multi-functional pointing and control device can support a large number of functions.

9. The method of claim 8 wherein said modes further include a default mode that is assumed when said selected mode could not be determined.

10. The multi-functional pointing and control device of claim 8 wherein a plurality of said controls are further equipped with sensitivity controls, whereby a user can adjust the response of said functions to said controls.

11. The multi-functional pointing and control device of claim 8 wherein said mode-selection means is a hardware control that is capable of generating a set of distinct mode-selection signals, each said distinct mode-selection signal indicates a mode, said circuitry further includes a separate signal-processing channel for said mode-selection signals.

12. The multi-functional pointing and control device of claim 8 wherein said mode-selection means is provided by said controls, a predetermined distinct sequence of said control signals identifies a mode.

13. The multi-functional pointing and control device of claim 8 wherein said equipment further has a display and said mode-selection means is a mode-selection menu on said display and allowing users to select a mode.

14. A multi-functional pointing and control device to control a plurality of functions of a piece of equipment comprising:
(a) a plurality of controls, said controls being capable of generating control signals adequate to control each said function,
(b) a circuitry including a microprocessor and communication link to said equipment, said circuitry having plurality of signal-processing channels capable of processing said control signals, formatting them into suitable forms, and communicating them with said equipment via said communication link,
(c) a first mapping with a plurality of modes, in each said mode said controls mapping to a subset of said functions and being used exclusively to control said subset of functions, said first mapping being a many-to-many mapping where each said control can map to a plurality of said functions and vice versa,
(d) a second mapping where each said mode maps to a distinct set of said signal-processing channels,
(e) a mode-selection means that allows users to indicate a selected mode from all said modes, said mode-selection means connects said controls to said distinct set of signal-processing channels that maps to said selected mode according to said second mapping, said mode-selection means may include necessary signal conversion elements to convert said control signals into compatible forms, said equipment identifying said selected mode according to said second mapping and using said control signals exclusively to control said set of functions according to said second mapping,
whereby each said control is shared by multiple said functions, whereby all said functions are controlled by the same set of said controls in a uniform and consistent manner, and whereby a small number of said controls can control a large number of said functions.

15. The multi-functional pointing and control device of claim 14 wherein a plurality of said controls are further equipped with sensitivity controls, whereby a user can adjust the response of said functions to said controls.

16. The multi-functional pointing and control device of claim 14 wherein said first mapping is alterable, whereby a user can customize said first mapping.
